(19) United States
(12) Patent Application Publication
(10) Pub. No.: US 2015/0248193 A1
(43) Pub. Date: Sep. 3, 2015

(54) CUSTOMIZED USER INTERFACE FOR MOBILE COMPUTERS

(71) Applicant: Fuhu Holdings, Inc., El Segundo, CA (US)

(72) Inventor: Robb Fujioka, Manhattan Beach, CA (US)

(73) Assignee: Fuhu Holdings, Inc., El Segundo, CA (US)

(21) Appl. No.: 14/193,488

(22) Filed: Feb. 28, 2014

(51) Int. Cl. G06F 3/0482; G06Q 30/06; G06Q 30/02

(52) U.S. Cl. CPC G06F 3/0482; G06Q 30/0269; G06Q 30/0255; G06Q 30/0641

(57) ABSTRACT

The present invention is a customized user interface for a mobile computer device and method of operating a mobile computer device. The invention enhances a user's experience in using the mobile computer by gathering information regarding the user's use of the device, and then moving relevant applications, utilities, and content so that they are more accessible to the user on the interface. The interface or display on the mobile computer device screen is also customizable by the user.

### FIELD OF THE INVENTION

This invention relates, generally, to an electronic data processing unit device and electronic data processing unit based method for operating an electronic data processing unit device. In particular, the invention is a software based customized user interface for a tablet computer that: (1) tracks the usage of the tablet computer; (2) compiles the tracking data; and (3) enhances a user's experience of the tablet computer by shifting or reorganizing the relevant applications, utilities, content, and advertisements on the tablet computer to better suit the user.

### BACKGROUND OF THE INVENTION

For decades, electronic data processing units, or computers, have been available as mobile computing devices, including laptops, tablet computers, personal digital assistants (PDAs), smartphones, portable gaming devices, and portable digital media players. These mobile computing devices allow users to draft documents on-the-go, continuously check email and other messages outside the office, and play, shop online, read, view, and experience various media content, from just about any location on the planet.

One important aspect of the mobile computing device is the user interface (“UI”) also known as the graphical user interface (“GUI”). The UI functions as the important gatekeeper, in which users can organize, access, and manipulate various content, programs, and applications on their mobile computing device. The UI primarily displays applications and content, and shortcuts thereto, in a format with which a user may directly engage. The purpose of the UI is to provide the user friendly access to the wide variety of functions of the electronic data processing unit and enable the user to perform common tasks quickly such as opening documents, browsing the Internet, accessing content, and playing games.

Although UIs generally contain organized shortcuts—typically alphabetically—many UIs do not provide the user with the necessary functionality for providing improved accessibility to relevant content and/or applications. With laptops and tablet computers, which often have UIs that are more complex than with what is found on a smartphone, the complex layering of the UI creates a maze that the user must go through to access the desired program. This maze creates confusion and frustration with novice users. Regarding smartphone devices, typically, the entire main screen of the UI is wholly engulfed by poorly organized shortcuts, distracting the user from locating a specific application. As such, it would be beneficial to readily convey relevant applications and content to users in an organized manner. Examples of beneficial shifting might include moving relevant applications and content to a location that is preferred by the user or having toolbars that provide quick access to relevant applications and content.

Unfortunately, the UIs of many mobile computing devices do not provide visually appealing and customizable features. Further, currently available UIs certainly do not automatically reorganize content, applications, and shortcuts in synch with the usage of the content, applications, and shortcuts. Although many mobile computing devices, such as smartphones include the option to change the background image, the ability for the user to change the presentation of the shortcuts, toolbars, and content is very limited. Laptops and tablet computers generally have more flexibility in the customization of the UI, such as changing the color scheme, but this customization is currently very limited. Accordingly, it would be beneficial to have a UI that provides users with visually appealing features or more flexible options in visually modifying a UI. It would also be beneficial to have a mobile electronic data processing unit that tracks the usage of the content and applications on that mobile unit and automatically reorganizes the content and applications to benefit the user.

Therefore, what is needed is a customizable UI that provides users with easy access to relevant applications and content tailored to the user's preferences and usage of the mobile electronic data processing unit. The mobile electronic data processing unit would collect information regarding usage and this information would be used to automatically improve the accessibility of content and applications that are accessed or used more frequently.

### SUMMARY OF THE INVENTION

To minimize the limitations in the prior art, and to minimize other limitations that will become apparent upon reading and understanding the present specification, the present invention discloses a mobile computing device configured with a new and useful customized user interface and method of optimizing the mobile computing device.

In a preferred embodiment, the invention is a tablet computer that has a graphical user interface that overlaps the operating system of the tablet computer and provides enhanced functionality. The specially programmed tablet computer tracks the usage of the applications, utilities, and contents on the computer and rearranges them on the computer to make the most used ones more readily accessible to the user. The interactive graphical user interface also allows the user to customize the look and feel of the interface and shift the locations of the programs, applications, utilities, and content on the tablet computer.

One embodiment of the invention is a customized user interface method configured to shift one or more relevant applications or content to a user. The method comprises the steps of: displaying a user interface on one or more display screens of a mobile device; detecting one or more input selections associated with the user interface; converting the one or more input selections into one or more electronic signals; updating a data collection record based upon the one or more input selections performed by the user; retrieving the one or more relevant applications or content based upon the data collection record; and modifying the user interface to display the one or more relevant applications or content based at least in part upon the data collection record. The user interface displays a plurality of selectable regions and the plurality of selectable regions at least partially circumscribe a region on the one or more display screens. The one or more input selections are made by the user and are received by a sensory surface. The sensory surface converts the one or more input selections into the one or more electronic signals. The mobile device includes a computer program. The computer program updates the data collection record, in response to the one or more electronic signals as represented on the user interface. The computer program selects the one or more relevant applications or content, and the one or more relevant applications or content is displayed in the plurality of selectable regions in sequential order based upon relevance of the data collection record. Preferably, the user interface includes one or more toolbars, which are generally displayed on the one or more display devices. The one or more toolbars typically includes one or more shortcuts of the one or more relevant applications, and the one or more shortcuts are preferably configured to allow the user to activate the one or more relevant applications. The plurality of selectable regions is preferably configured to scroll vertically and horizontally. The one or more toolbars are also preferably configured to scroll vertically and horizontally. Preferably, the mobile device is a tablet computer. The one or more input selections may be produced by a keyboard device. Preferably, the one or more toolbars includes a dock. Preferably, the dock further comprises of a shortcuts bar and a quick access bar. The shortcuts bar typically includes the one or more shortcuts. The quick access bar typically includes one or more shortcuts. The shortcuts bar is generally configured to allow the user to select the one or more shortcuts. The quick access bar is generally configured to prevent the user from selecting the one or more shortcuts. The one or more shortcuts may be a customization utility, which provides means for changing the color and content of the user interface. The data collection record generally corresponds to a group consisting of: usage of the mobile device, profile information of the user, quiz or survey information provided by the user, purchase history of the user, one or more applications and content selected by the user, location of the user, application usage of the user, and information based upon device tracking. Preferably, the one or more relevant applications or content includes: under twenty, a deal application store, and a digital photo frame. Under twenty is an application that generally provides tangible goods and service purchases less than twenty dollars. The deal application store generally provides relevant deals base upon the data collection record. The digital photo frame application generally includes: one or more photos selected by the user; weather based on the location of the user, current date and time, the one or more social network feeds, and one or more relevant sales of tangible goods.

Another embodiment of the invention is a mobile computer device with a customized user interface configured to provide enhanced functionality to a user in managing and accessing one or more relevant applications or content. The mobile computer device comprises of: a mobile device; one or more display screens; a sensory surface; a user interface; and a computer program. The one or more display screens are coupled on the front face of the mobile device. The sensory surface is coupled to the mobile device and receives one or more selection signals from the user. The sensory surface converts the one or more selection signals into one or more electronic signals within the mobile device. The user interface is visible on the one or more display screens and displays one or more relevant applications or content in the one or more display screens. The computer program substantially resides in the mobile device and updates a data collection record by analyzing the one or more electronic signals received by the computer program. The computer program also generates the one or more relevant applications or content by analyzing the data collection record. Preferably, the user interface includes one or more toolbars. The one or more toolbars is generally displayed on the one or more display devices and generally includes one or more shortcuts of the one or more relevant applications. The one or more shortcuts are typically configured to allow the user to activate one or more relevant applications or content. The plurality of selectable regions is preferably configured to scroll vertically and horizontally and the one or more toolbars is preferably configured to scroll vertically and horizontally. Generally, the one or more toolbars includes a dock. The dock typically includes a shortcuts bar and a quick access bar. The shortcuts bar typically includes the one or more shortcuts. The quick access bar typically includes the one or more shortcuts. Generally, the shortcuts bar is configured to allow the user to select the one or more shortcuts. Generally, the quick access bar is configured to prevent the user from selecting the one or more shortcuts. Preferably, the sensory surface substantially overlaps the one or more display screens, and the one or more display screens is preferably a touchscreen. The sensory surface, however, may be a keyboard device. Preferably, the mobile device is a tablet computer. Preferably, the computer program incrementally changes the appearance of the user interface based upon the one or more input selections. Preferably, the data collection record corresponds to a group consisting of: usage of the mobile device, profile information of the user, quiz or survey information provided by the user, purchase history of the user, one or more applications and content selected by the user, location of the user, application usage of the user, and information based upon device tracking. Preferably, the one or more relevant applications or content includes: under twenty, a deal application store, and a digital photo frame. Under twenty is an application that generally provides tangible goods and service purchases less than twenty dollars. The deal application store generally provides relevant deals base upon the data collection record. The digital photo frame application generally includes: one or more photos selected by the user; weather based on the location of the user, current date and time, the one or more social network feeds, and one or more relevant sales of tangible goods.

Another embodiment of the invention is a computer-based method of optimizing a user interface for an electronic data processing unit, the steps comprising: providing an electronic data processing unit; wherein the electronic data processing unit is comprised of one or more display screens, a plurality of applications; a plurality of utilities; a plurality of content files; displaying on the one or more display screens the plurality of applications, the plurality of utilities, and the plurality of content files; operating the electronic data processing unit by a user to access the plurality of applications, the plurality of utilities, and the plurality of content files; gathering by the electronic data processing unit a plurality of information about the user as the user operates the electronic data processing unit; determining by the electronic data processing unit a plurality of frequencies at which of the plurality of applications, the plurality of utilities, and the plurality of content files are accessed; organizing the plurality of applications, the plurality of utilities, and the plurality of content files by the electronic data processing unit on the one or more display screens based on the plurality of frequencies at which the plurality of applications, the plurality of utilities, and the plurality of content files are accessed. Preferably, the method further comprises the steps of: displaying by the electronic data processing unit on the one or more display screens during operation of the electronic data processing unit by the user a plurality of advertisements; wherein the plurality of advertisements displayed are based on the plurality of information about the user gathered by the electronic data processing unit as the user operates the electronic data processing unit; purchasing a plurality of goods on the electronic data processing unit by the user; wherein the plurality of information about the user gathered as the user operates the electronic data processing is further comprised of the plurality of goods purchased by the user; and displaying by the electronic data processing unit a plurality of advertisements based on the plurality of goods purchased by the user. The steps may also include displaying by the electronic data processing unit on the one or more display screens a home screen; wherein the home screen is comprised of a plurality of channel bars; and wherein the plurality of channel bars are comprised of the plurality of applications, the plurality of utilities, and the plurality of content files. The steps preferably include organizing the plurality of channel bars on the one or more display screens based on the plurality of frequencies at which the plurality of applications, the plurality of utilities, and the plurality of content files are accessed. Preferably, the home screen is further comprised of a dock; wherein the dock is displayed on the one or more display screens by the electronic data processing unit; wherein the dock is comprised of at least one short cut bar and at least one access bar; wherein the at least one short cut bar is comprised of at least one selected application of the plurality of applications; wherein the at least one selected application is directly accessible by the user from the at least one short cut bar; wherein the at least one access bar is comprised of at least one selected utility of the plurality of utilities; and wherein the at least one selected utility is directly accessible by the user from the at least one access bar. Typically, the plurality of channel bars is comprised of a purchasing bar; wherein the purchasing bar is comprised of one or more purchasing utilities; wherein the one or more purchasing utilities is comprised of an applications purchasing utility and a goods purchasing utility; wherein the plurality of utilities is comprised of a digital photo frame utility; wherein the digital photo frame utility is comprised of one or more digital images, a weather display, a date display, a time display, a social network display, at least one of the one or more purchasing utilities; wherein the plurality of utilities is further comprised of a settings utility; wherein the settings utility allows the user to customize the electronic data processing unit; and wherein the computer-based method further comprises a step of customizing by the user the electronic data processing unit through the settings utility. Preferably, the settings utility is comprised of one or more data gathering applications and the method includes the steps of accessing by the user the one or more data gathering applications; answering by the user a plurality of questions posed by the one or more data gathering applications; gathering by the electronic data processing unit one or more answers provided by the user; and combining by the electronic data processing unit the one or more answers provided by the user with the plurality of information about the user gathered by the electronic data processing unit as the user operates the electronic data processing unit. Preferably, the electronic data processing unit is mobile.

Another embodiment of the invention is a mobile electronic data processing unit optimized to enhance the user interface based on usage, comprising: a mobile electronic data processing unit; wherein the mobile electronic data processing unit is comprised of one or more display screens, a plurality of applications; a plurality of utilities; a plurality of content files; wherein the plurality of applications, the plurality of utilities, and the plurality of content files are displayed on the one or more display screens; wherein as the user operates the mobile electronic data processing unit, the mobile electronic data processing unit gathers a plurality of information about the user; gathering the plurality of information about the user by the mobile electronic data processing unit; determining by the mobile electronic data processing unit a plurality of frequencies at which of the plurality of applications, the plurality of utilities, and the plurality of content files are accessed; organizing the plurality of applications, the plurality of utilities, and the plurality of content files by the mobile electronic data processing unit on the one or more display screens based on the plurality of frequencies at which the plurality of applications, the plurality of utilities, and the plurality of content files are accessed. Preferably, the user purchases a plurality of goods on the mobile electronic data processing unit; wherein the plurality of information about the user gathered as the user operates the mobile electronic data processing unit is further comprised of the plurality of goods purchased by the user; wherein the mobile electronic data processing unit displays a plurality of advertisements on the one or more display screens during operation of the mobile electronic data processing unit by the user; and wherein the plurality of advertisements displayed are based on the plurality of information about the user gathered by the mobile electronic data processing unit as the user operates the mobile electronic data processing unit. The mobile electronic data processing unit is preferably further comprised of a home screen; wherein the home screen is displayed on the one or more display screens; wherein the home screen is comprised of a plurality of channel bars; wherein the plurality of channel bars are comprised of the plurality of applications, the plurality of utilities, and the plurality of content files; wherein the mobile electronic data processing unit organizes the plurality of channel bars on the one or more display screens based on the plurality of frequencies at which the plurality of applications, the plurality of utilities, and the plurality of content files are accessed by the user; wherein the home screen is further comprised of a dock; wherein the dock is comprised of at least one short cut bar and at least one access bar; wherein the at least one short cut bar is comprised of at least one selected application of the plurality of applications; wherein the at least one selected application is directly accessible by the user from the at least one short cut bar; wherein the at least one access bar is comprised of at least one selected utility of the plurality of utilities; wherein the at least one selected utility is directly accessible by the user from the at least one access bar; wherein the plurality of channel bars is comprised of a purchasing bar; wherein the purchasing bar is comprised of one or more purchasing utilities; and wherein the one or more purchasing utilities is comprised of an applications purchasing utility and a goods purchasing utility. Preferably, the plurality of utilities is comprised of a digital photo frame utility and a settings utility; wherein the digital photo frame utility is comprised of one or more digital images, a weather display, a date display, a time display, a social network display, at least one of the one or more purchasing utilities; wherein the settings utility allows the user to customize the mobile electronic data processing unit; wherein the user uses the settings utility to customize the mobile electronic data processing unit; wherein the settings utility is comprised of one or more data gathering applications; wherein the user accesses the one or more data gathering applications and provides a one or more answers to a plurality of questions posed by the one or more data gathering applications; wherein the mobile electronic data processing unit combines the one or more answers provided by the user with the plurality of information about the user gathered by the mobile electronic data processing unit as the user operates the mobile electronic data processing unit.

Another embodiment of the invention is a computer-based method of optimizing a user interface for an electronic data processing unit, the steps comprising: providing a mobile electronic data processing unit; wherein the mobile electronic data processing unit is comprised of one or more display screens, a plurality of applications; a plurality of utilities, a plurality of content files, and a home screen; wherein the home screen is comprised of a dock and a plurality of channel bars; wherein the dock is comprised of at least one short cut bar and at least one access bar; wherein the at least one short cut bar is comprised of at least one selected application of the plurality of applications; wherein the at least one access bar is comprised of a digital photo frame utility and a settings utility; wherein one of the plurality of channel bars is a purchasing bar; wherein the purchasing bar is comprised of one or more purchasing utilities; wherein the one or more purchasing utilities is comprised of an applications purchasing utility and a goods purchasing utility; wherein the digital photo frame utility is comprised of one or more digital images, a weather display, a date display, a time display, a social network display, at least one of the one or more purchasing utilities; wherein the settings utility allows a user to customize the mobile electronic data processing unit; wherein the settings utility is comprised of one or more data gathering applications; operating the mobile electronic data processing unit by the user to access the plurality of applications, the plurality of utilities, and the plurality of content files; purchasing a plurality of goods by the user with the goods purchasing utility; purchasing a plurality of new applications by the user with the applications purchasing utility; gathering by the mobile electronic data processing unit a plurality of information about the user as the user operates the mobile electronic data processing unit; accessing by the user the one or more data gathering applications; answering by the user a plurality of questions posed by the one or more data gathering applications; gathering by the mobile electronic data processing unit one or more answers provided by the user; wherein the plurality of information includes the plurality of goods purchased by the user, and the plurality of new applications purchased by the user and includes the one or more answers provided by the user; determining by the mobile electronic data processing unit a plurality of frequencies at which of the plurality of applications, the plurality of utilities, and the plurality of content files are accessed; organizing the plurality of applications, the plurality of utilities, and the plurality of content files by the mobile electronic data processing unit on the one or more display screens based on the plurality of frequencies at which the plurality of applications, the plurality of utilities, and the plurality of content files are accessed; displaying by the mobile electronic data processing unit on the one or more display screens during operation of the mobile electronic data processing unit by the user a plurality of advertisements; wherein the plurality of advertisements displayed are based on the plurality of information about the user gathered by the mobile electronic data processing unit as the user operates the mobile electronic data processing unit; organizing the plurality of channel bars on the one or more display screens based on the plurality of frequencies at which the plurality of applications, the plurality of utilities, and the plurality of content files are accessed.

The present invention may include a universal serial bus device, which includes the computer program. Once the universal bus device couples to the mobile electronic computing device, the universal serial bus device may transfer the computer program into the mobile device. Any type of storage device that contains the computer program may used without deviating from the scope of the invention.

The present invention may include several display screens, of which the home page is preferably the center screen. The screens may be swapped via the standard swiping motion.

Another embodiment of the present invention may include an enhanced buying experience by enabling the user interface to save the user's payment information. The user's payment information may be used to enable a one-click buy, which provides for a more convenient shopping experience.

It is an object of the present invention to provide the user with a mobile electronic data processing unit that gathers information as the user operates the mobile unit and makes purchases using the unit. It is also an object of the invention to provide an inexpensive and easy to use interactive graphical user interface that comes preloaded on a mobile computer such as a tablet computer.

It is an object of the present invention to provide the user with easy access to one or more relevant applications or content. Specifically, the present invention may include a library of widgets in one or more display screens to organize the one or more relevant content. The present invention may also include a folder organizer to organize newly purchased applications or one or more toolbars for quick access of relevant applications.

It is an object of the present invention to overcome the limitations of the prior art.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is an illustration of a perspective view of one embodiment of the mobile electronic data processing unit of the present invention.

FIG. 2 is a block diagram of one embodiment of the method of the present invention.

FIG. 3 is an illustration of one embodiment of the user interface software program and shows the home screen.

FIG. 4 is an illustration of one embodiment of the user interface software program and shows the weather channel bar being accessed.

FIG. 5 is an illustration of one embodiment of the user interface software program and shows the purchasing channel bar being accessed.

FIG. 6 is an illustration of one embodiment of the user interface software program and shows the news feed application.

FIG. 7 is an illustration of one embodiment of the applications purchasing utility of the present invention.

FIG. 8 is an illustration of one embodiment of the goods purchasing utility of the present invention.

FIG. 9 is an illustration of one embodiment of the digital frame utility of the present invention.

FIG. 10 is an illustration of one embodiment of the settings utility of the present invention.

FIG. 11 is an illustration of one embodiment of the My Profile settings utility of the present invention.

### DETAILED DESCRIPTION OF THE DRAWINGS

In the following detailed description of various embodiments of the invention, numerous specific details are set forth in order to provide a thorough understanding of various aspects of one or more embodiments of the invention. However, one or more embodiments of the invention may be practiced without some or all of these specific details. In other instances, well-known methods, procedures, and/or components have not been described in detail so as not to unnecessarily obscure aspects of embodiments of the invention.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the screen shot figures, and the detailed descriptions thereof, are to be regarded as illustrative in nature and not restrictive. Also, the reference or non-reference to a particular embodiment of the invention shall not be interpreted to limit the scope of the invention.

The UI of the mobile device of the present invention organizes applications and content based upon a user's needs in a visually appealing and organized manner. The present invention prioritizes each relevant content and application based upon the usage of the mobile device; the user's profile information; quiz or survey information provided by the user; purchase history of the user; relevant applications and content selected by the user; location of the user; application usage of the user; and information based upon device tracking. Upon analyzing the information, the present invention shifts relevant content and/or applications based upon the user's preferences. Additionally, the present invention organizes such applications and content in a way that they can be accessed uniformly and conveniently.

In the following description, certain terminology is used to describe certain features of one or more embodiments of the invention. For instance, “computer” and “electronic data processing unit” refer to any device that processes information with an integrated circuit chip, including without limitation, mainframe computers, work stations, servers, desktop computers, portable computers, laptop computers, embedded computers, wireless devices including cellular phones, tablet computers, personal digital assistants, digital media players, portable game players, and hand-held computers; “internet” refers to any collection of networks using standard protocols, whether Ethernet, ATM, FDDI, WI-FI, Token ring, or any combination thereof. Gathering or collecting data and information may be accomplished by any mechanism, including, but not limited to a keyboard, mouse, soft key keypad, touchscreen, stylus, finger, or pressure device. A storage device refers to RAM, flash drive, or other writable data structure that can receive data and write that data to a data storage device.

The tracking of the usage is accomplished by collecting data, or information, such as usage of the device, input of profile information, answers to quizzes or surveys provided by the user, purchasing history, a user's click through on advertisements and other content, location(s) of the device, application usage, and device tracking.

Based on the gathered data, the device and method of the present invention are able to automatically bring to the user's attention relevant applications (or Apps), content, and more relevant advertisements. Accordingly, the providers of the interactive graphical user interface and/or device with the interactive graphical user interface will be able to sell advertisements for a higher cost because the user's will have a much higher click through rate. The present invention preferably includes a unique commerce utility that saves the user's payment information and enables one click purchases, which in turn provides a much more convenient shopping experience through the mobile computing device. The commerce or purchasing utility should have at least two types of purchasing applications, or stores. The first is to purchase programs (or Apps) for the mobile computing device, and the second is to purchase tangible goods. Unique deals or discounted items, such as coupons provided by national or local merchants to all users of the present invention will also be available.

Preferably, the present invention also has a library of widgets and/or gadgets that are targeted to vertical markets that can be added to one or more of the main screens of the invention. In computer programming, a “widget” (or control) is an element of a graphical user interface that displays an information arrangement changeable by the user, such as a window or a text box. The defining characteristic of a widget is to provide a single interaction point for the direct manipulation of a given kind of data. In other words, widgets are basic visual building blocks, which, combined in an application, hold all the data processed by the application and the available interactions on this data. In the software industry, “gadget” refers to computer programs that provide services without needing an independent application to be launched for each one, but instead runs in an environment that manages multiple gadgets.

With the collected information, the present invention is able to recommend relevant widgets to be purchased, which benefits the producer of the present invention, because higher ad revenue on the widgets is generated. Moreover, use of the widgets is tracked by the present invention, which allows even more information to be collected and/or gathered.

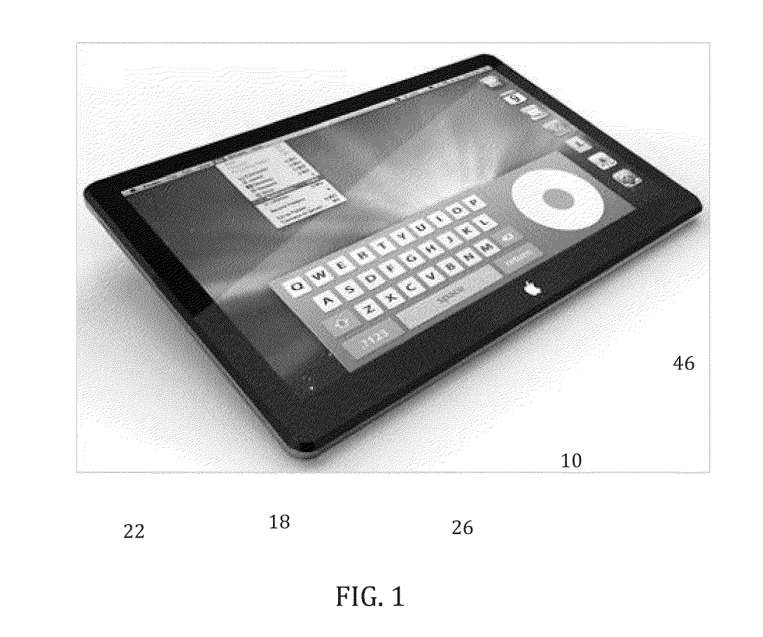

FIG. 1 is an illustration of a perspective view of one embodiment of the mobile electronic data processing unit of the present invention. As shown in FIG. 1, the electronic processing unit device 26 is preferably mobile and is programmed with a user interface software program 10. The electronic data processing unit device 26 preferably has one or more display screens 22, which displays an interactive graphical display 18. Preferably, the electronic data processing unit device 26 further includes a sensory input surface 46, which allows the user to interact with the electronic data processing unit device 26. The electronic data processing unit device 26 configured or programmed with the user interface software program 10 may also include other devices attached to the electronic data processing unit device 26 without deviating from the scope of the invention. The electronic data processing unit device 26 is preferably a specially programmed general-purpose computing device that is preferably mobile so that it can be moved easily from place to place. The electronic data processing unit device 26 is preferably a tablet computer, but any type of computing device such as a laptop or smartphone may be used without deviating from the scope of the invention. The one or more display screens 22 are typically coupled to the front face of the electronic data processing unit device 26 and displays electronic information to the user.

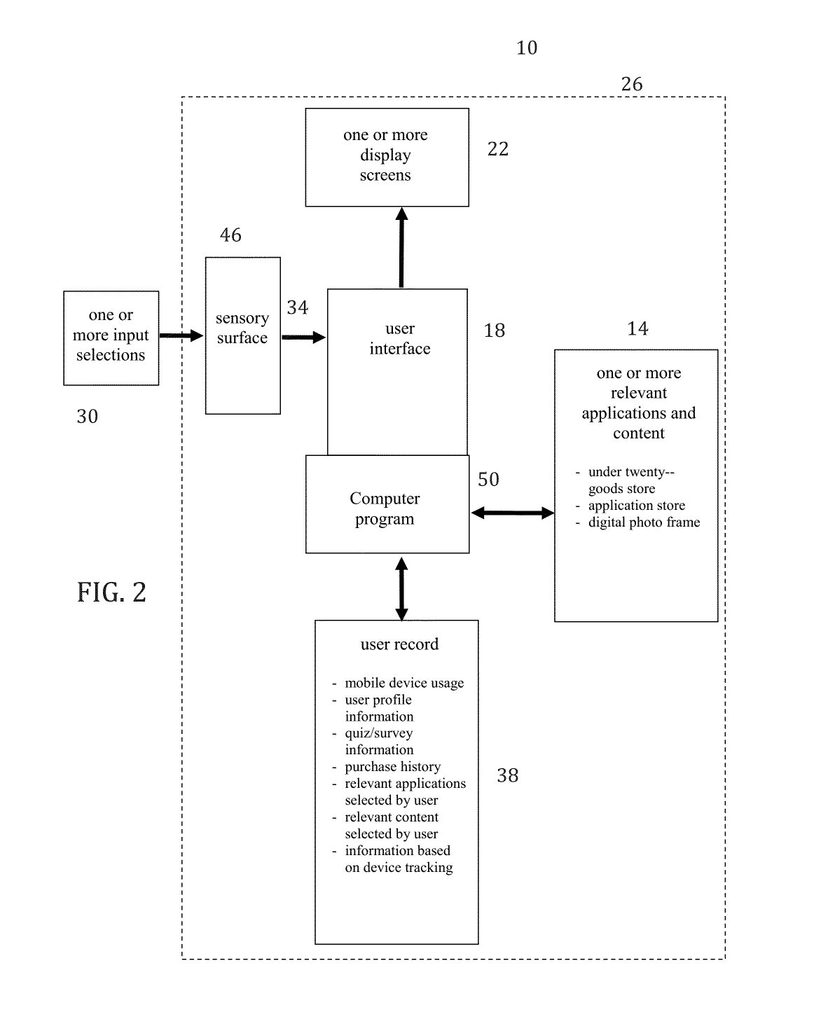

FIG. 2 is a block diagram of one embodiment of the method of the present invention. As shown in FIG. 2, the user interface software program 10 preferably includes: an electronic data processing unit device 26; one or more display screens 22; a sensory input surface 46; an interactive graphical display 18, which is preferably a software computer program 50; data collection record 38; and one or more relevant applications, utilities, and content 14. The user interface software program 10 may also include other devices without deviating from the scope of the invention. Preferably, the interactive graphical display 18 is displayed on the one or more display screens 22 of the electronic data processing unit device 26. A user provides one or more input selections 30 to the electronic data processing unit device 26 by means of word typing or physical touching. The one or more input selections 30 made by the user are detected by the sensory surface 46. Preferably, the sensory surface 46 resides within the one or more display screens 22 of the electronic data processing unit device 26, but the sensory surface 46 may be separated from the one or more display screens 22 and/or electronic data processing unit device 26. The sensory surface 46 receives the one or more input selections 30 from the user and converts such inputs into one or more electronic signals 34, which are received by the interactive graphical display 18. The sensory surface 46 is preferably a touchscreen but any type of input device such as a keyboard device may be used without deviating from the scope of the invention. The interactive graphical display 18 preferably resides in the electronic data processing unit device 26 and is substantially visible in the one or more display screens 22 once the electronic data processing unit device 26 is powered on. The interactive graphical display 18 then typically sends the one or more electronic signals 34 to the computer program 50. The computer program 50 substantially resides in the electronic data processing unit device 26 and interacts with the interactive graphical display 18, but the computer program 50 may reside outside the electronic data processing unit device 26 such as being stored in a universal serial bus device. The computer program 50 is typically another software application that runs alongside the standard operating system of the electronic data processing unit device 26 but may be part of that standard operating system without deviating from the scope of the invention. The data collection record 38 is updated through tracking of the device and through user input. The tracking of the usage is accomplished by collecting data, or information, such as usage of the device, input of profile information, answers to quizzes or surveys provided by the user, purchasing history, a user's click through on advertisements and other content, location(s) of the device, application usage, and device tracking. However, other types of information may be collected in order to generate a data collection record 38 without deviating from the scope of the invention.

The user interface software program 10 enhances the user's experience by shifting one or more relevant applications, utilities or content 14 in the interactive graphical display 18. Shifting, moving, optimizing, or reorganizing the one or more relevant applications, utilities, and content 14 by the user interface software program 10 makes the electronic data processing unit device 26 easier to use and makes the applications, utilities, and content 14 visible and more accessible in the one or more display screens 22.

We should Insert Here More Information on how the User Interface Software Program Operates.

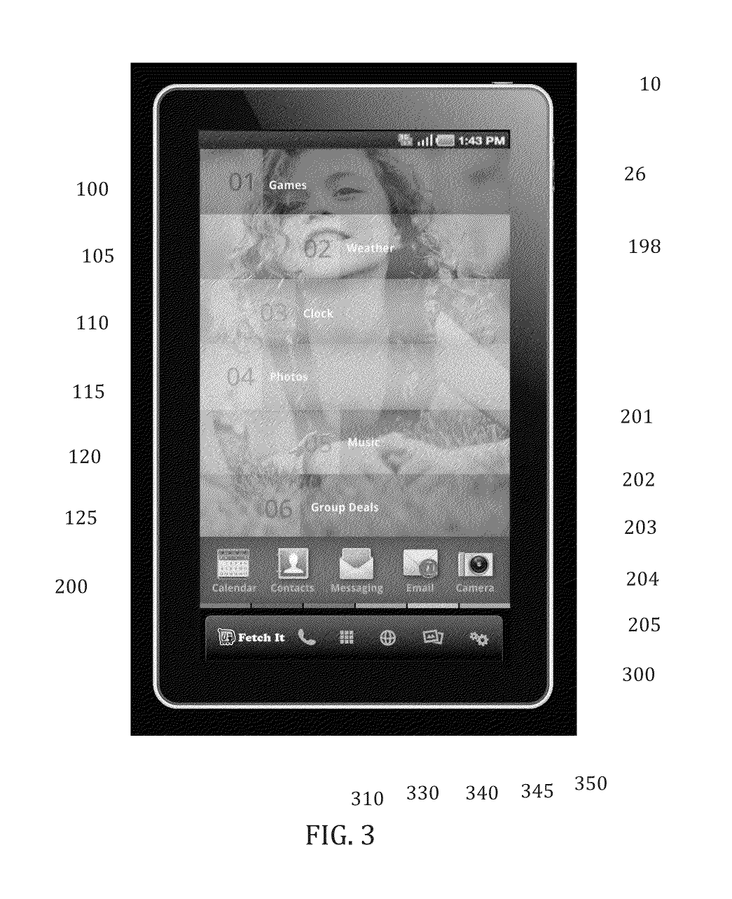

FIG. 3 is an illustration of one embodiment of the user interface software program and shows the home screen. As shown in FIG. 3, the user interface software program 10 is preferably a software program loaded on an electronic data processing unit device 26. The interactive graphical display 18 of the user interface software program 10 is preferable displayed on one or more displays 22 of electronic data processing unit device 26. FIG. 3 shows that the home screen of user interface software program 10, which overlays the standard operating system of the device, similar to how Windows® overlays a personal computer OS, preferably includes channel bars 100, 105, 110, 115, 120, and 125, dock 199, short cut bar 200, quick access (or just access) bar 300, and background photo 198. The channel bars may include games channel bar 100, weather channel bar 105, clock channel bar 110, photos channel bar 115, music channel bar 120, and purchasing (or “deals”) channel bar 125. Short cut bar 200 is preferably comprised of the most used applications or utilities by the user, including, calendar 201, contacts 202, messaging 203, email 204, and camera 205. The short cut bar 200 allows the user to directly access the most used applications, which means that a single click on the icons of the short cut bar will pull up the standard default application. Access bar 300 preferably includes the premium features and utilities that are preferably an integral and important part of the user interface software program 10, including, but not limited to: trademark logo 310, App List 330, Web 340, digital photo frame utility 345, and settings utility 350. Preferably, the App List 330 and Web 340 are preferably the standard applications that come with the standard operating system of the electronic data processing unit device 26.

Preferably, the user may vertically swipe the home screen and access additional channel bars, including bars for news feed and social media.

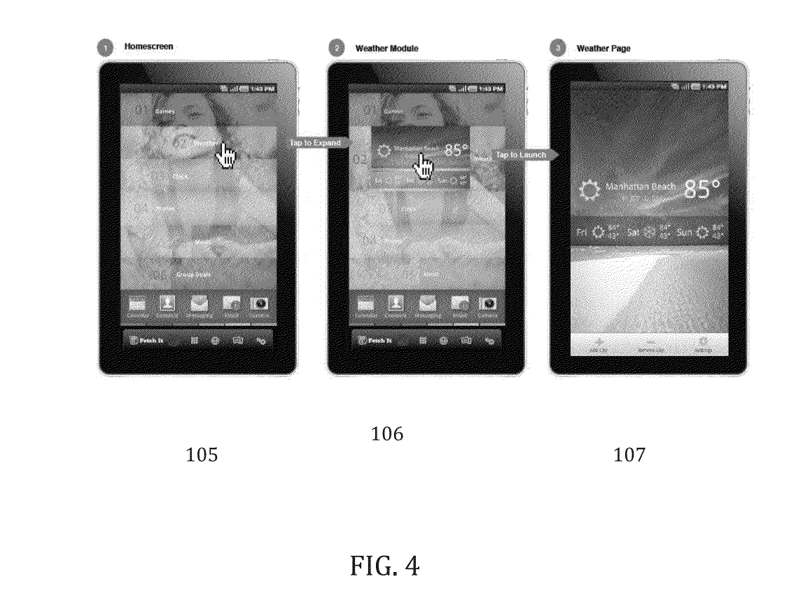

FIG. 4 is an illustration of one embodiment of the user interface software program and shows the weather channel bar being accessed. As shown in FIG. 4, the user selects, usually by touch, one of the channel bars. In this case, weather channel bar 105 is selected. When selected, the channel bar 105 expands vertically to provide additional information 106 and pushes down the lowest displayed channels. Should the user require more information, the channel bar 105 (as well as any other channel bar) is selected, or tapped, again to fully launch the application 107.

The other channel bars, such as channel bars 100, 110, 115, 120, and 125, preferably open in the same dual click mode. The clock channel bar 110 preferably links to an application that displays a Date, a Time, a Time Zone, and an Alarm Indicator. The clock application would allow the user to view multiple times from multiple time zones and set alarms. The photo channel bar 115 preferably links to the devices default photo application of the standard operating system. The music channel bar 120 preferably links to the devices default music application. The purchasing channel bar 125 preferably links to the deals or coupons that are being offered exclusively to users of the present invention

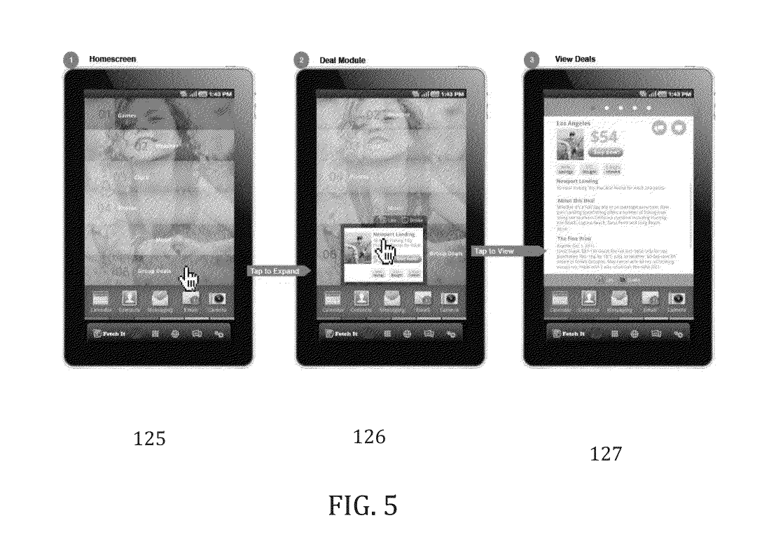

FIG. 5 is an illustration of one embodiment of the user interface software program and shows the purchasing channel bar being accessed. As shown in FIG. 5, the user selects, usually by touch, one of the channel bars. In this case, purchasing channel bar 125 is selected. When selected, the purchasing channel bar 125 expands vertically to provide additional information 126 and pushes down the lowest displayed channels. Should the user be interested in the deal or coupon that is being offered exclusively to users of the present invention, the additional information on the channel bar 126 (as well as any other channel bar) is selected, or tapped, again to fully launch the application 127. As part of data collecting, the user interface software program 10 tracks when a user “likes” or “dislikes” the deals as shown in FIG. 5. In this manner, the present invention may bring the user deals or purchasing opportunities that are more relevant to the user.

The purchasing application 127 is preferably an aggregation of multiple deal providers. The deals provided by the purchasing application 127 are preferably targeted based on the user's data that is collected by user interface software program 10. The purchasing application 127 preferably include an Apps store (also referred to as an applications purchasing utility) and a tangible goods store (also referred to as a goods purchasing utility) that are only available as part of the user interface software program 10. The Apps store and tangible goods store preferably allow the user to purchase via a one-click buy through payment system once a user has a credit card stored in the user interface software program 10.

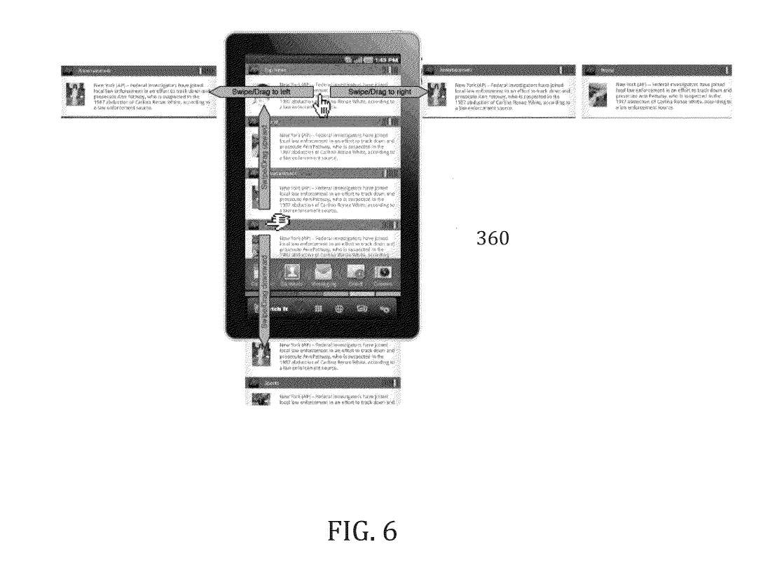

FIG. 6 is an illustration of one embodiment of the user interface software program and shows the news feed application. The new feed application 360 is preferably accessed from a news feed channel bar. The news feed application 360 is an application that allows a user to access a plurality of news, sports, and entertainment stories. If desired the news feed application may be set up to bring articles to the user's attention that are more relevant to what has been viewed before. FIG. 6 also shows how the news feed application 360 allows users to horizontally and vertically swipe to scroll the news feed.

Preferably, the social media channel bar links to the standard social media applications, which are part of the device's standard operating system.

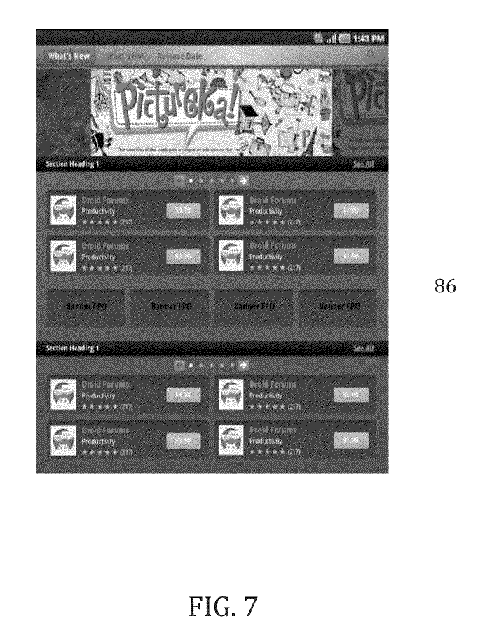

FIG. 7 is an illustration of one embodiment of the applications purchasing utility of the present invention. FIG. 7 shows a preferred format for the Apps store or applications purchasing utility 86 of the user interface software program 10.

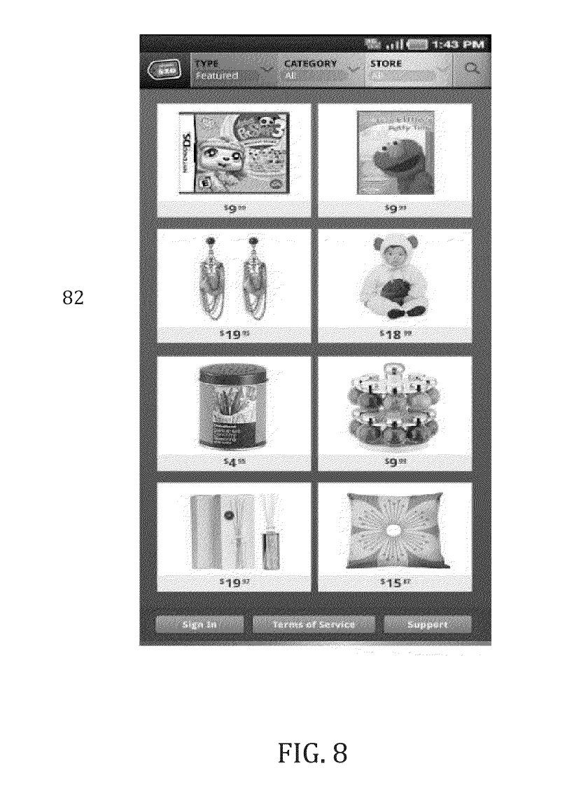

FIG. 8 is an illustration of one embodiment of the goods purchasing utility of the present invention. FIG. 8 shows a preferred format for the tangible goods store or goods purchasing utility 82 of the user interface software program 10.

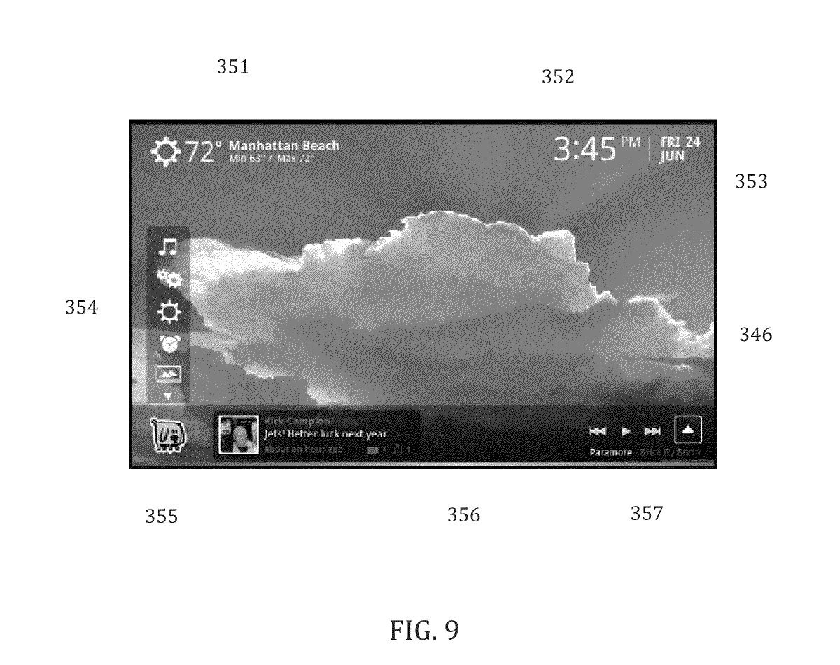

FIG. 9 is an illustration of one embodiment of the digital frame utility of the present invention. FIG. 9 shows that when the user clicks or otherwise selects the digital photo frame utility icon 345 (shown in FIG. 3), the digital photo frame utility 346 launches. As shown in FIG. 9, the digital photo frame utility 346, which is unique to the present invention, is comprised of weather display 351, clock display 352, a movie and/or photo slide show 353 (preferably a movie plays in the background for the start up of the digital photo frame utility 346, and then a photo or photo slide show is displayed), menu arrow 354, exit 355, social/news/deal feed 356, and music player 357. Preferably, the movie and/or photo slide show 353 shows images that relate to the weather of the users location. For example, if it is cloudy outside, images with clouds are displayed. Clicking on the menu arrow 354 preferably brings up a menu that allows users to select various utilities, applications, and content, including, but not limited to: clock, news, weather, music, photos, social media, and purchasing.

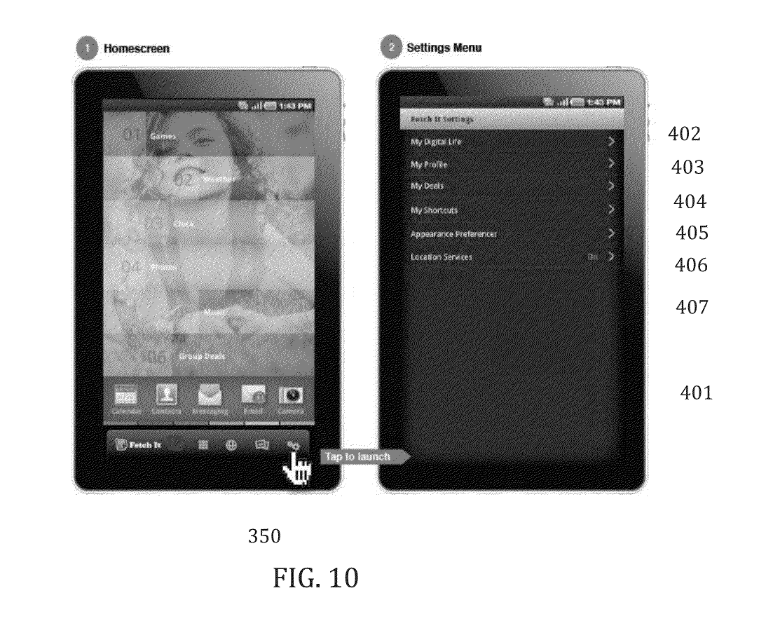

FIG. 10 is an illustration of one embodiment of the settings utility of the present invention. As shown in FIG. 10, when the user clicks the settings utility icon 350, the settings utility or application 401 is launched. The settings utility or application 401 preferably displays My Digital Life 402, My Profile 403, My Deals 404 (purchasing opportunities), My Shortcuts 405, appearance preferences 406, and location services 407. From the settings screen the user is able to customize the electronic data processing unit device 26, including selecting what content to be shown, how the applications, utilities, and content are shown, and selecting a color scheme. By clicking on My Digital Life 402, the user pulls up a secondary settings screen that preferably allows the user to set up the news feed application and the social media applications. The various news feeds that the user can sign up for include, but are not limited to: business, finance, entertainment, local, national, world, political, sports, and technology. The secondary settings screen also allows the user to directly access various applications, including, but not limited to: clock; weather; music; and photos. The set up process may include an option to select all or individual news fees and/or applications. If the user sets up the social media applications, the user must input user names and passwords.

My Shortcuts 405 allows the user to select what Applications are on the short cuts 200 (shown in FIG. 3).

From the appearance preferences 406, the user links to a utility that allows the user to customize the appearance, including color, of the channel bars, utilities, applications, contents, files, and backgrounds. The appearance preferences 406 also allows the user to base the appearance of the display on a standard or default appearance, customized by user, and/or optimized by usage. The default appearance of the channel bars is preferably, clock, news, music, photos, social, and weather.

Location services 407 allows the user to turn off the continuing information of any relevant applications and utilities of the user's current location. Each application is preferably switched on or off on an application by application basis.

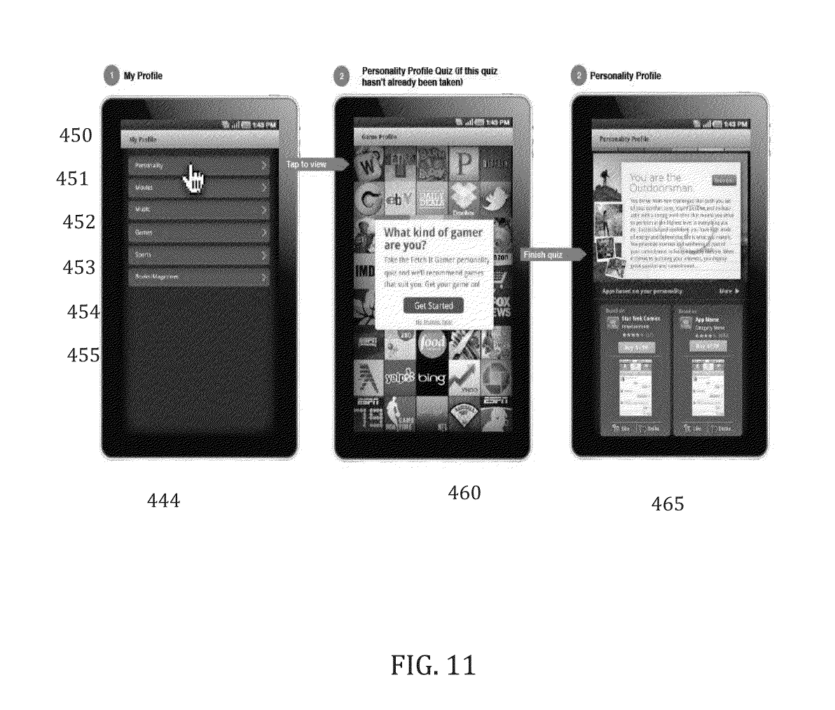

FIG. 11 is an illustration of one embodiment of the My Profile settings utility of the present invention. As shown in FIG. 11, when the user clicks on My Profile 403 (shown in FIG. 10), the My Profile settings application 444 is displayed. The My Profile settings application 444 is preferably comprised of several links to quizzes or data gathering applications, including, but not limited to: personality 450, movies 451, music 452, games 453, sports 454, and books/magazines 455. From each of these links the user preferably takes one or more quizzes, wherein the answers are collected as part of the information that is gathered from the usage of the device 26. FIG. 11 shows that the user has clicked on personality 450 and the personality profile quiz 460 is displayed. The user then takes this quiz, the data is stored (and used to optimize the user interface software program 10), and the user is preferably given a rewarding feedback, such as personality profile 465 and/or immediate links to goods and applications that are relevant to the user's personality. Each of the data gathering applications preferably has its own quiz and reward. The more quizzes the user takes, the more the user interface software program 10 can bring forth relevant content and advertisements, thereby optimizing the display of the applications, utilities, and content. If desired, the quizzes may be taken as many times as desired. The quizzes preferably ask the user what he or she likes about a given category.

If the user selects My Deals 404 (shown in FIG. 10), the deals or purchasing settings utility is displayed. That deals settings menu preferably includes the categories of big ticket, grocery, group, local, restaurant, and travel. Within the settings categories, the user is preferably asked to provide location and country information.

Preferably, the user interface software program 10 includes additional screens, which are horizontal from the home screen, and which are accessed by swiping back and forth. One of the screens is preferably a folder organizer, which is used by users to organize their Apps based on category type. Another one of the screens is preferably a widget and/or gadget library. The widgets and/or gadgets preferably provide a targeted user experience for the users across vertical markets.

Unless otherwise stated, all measurements, values, ratings, positions, magnitudes, sizes, locations, and other specifications which are set forth in this specification, including in the claims which follow, are approximate, not exact. They are intended to have a reasonable range which is consistent with the functions to which they relate and with what is customary in the art to which they pertain.

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope the invention. It is intended that the scope of the invention not be limited by this detailed description, but by the claims and the equivalents to the claims that are appended hereto.

Except as stated immediately above, nothing which has been stated or illustrated is intended or should be interpreted to cause a dedication of any component, step, feature, object, benefit, advantage, or equivalent to the public, regardless of whether it is or is not recited in the claims.

What is claimed is:

1. A computer-based method of optimizing a user interface for an electronic data processing unit, the steps comprising:
providing an electronic data processing unit;
wherein said electronic data processing unit is comprised of one or more display screens, a plurality of applications; a plurality of utilities; a plurality of content files;
displaying on said one or more display screens said plurality of applications, said plurality of utilities, and said plurality of content files;
operating said electronic data processing unit by a user to access said plurality of applications, said plurality of utilities, and said plurality of content files;
gathering by said electronic data processing unit a plurality of information about said user as said user operates said electronic data processing unit;
determining by said electronic data processing unit a plurality of frequencies at which of said plurality of applications, said plurality of utilities, and said plurality of content files are accessed; and
organizing said plurality of applications, said plurality of utilities, and said plurality of content files by said electronic data processing unit on said one or more display screens based on said plurality of frequencies at which said plurality of applications, said plurality of utilities, and said plurality of content files are accessed.

2. The computer-based method of optimizing a user interface for an electronic data processing unit of claim 1, the steps further comprising:
displaying by said electronic data processing unit on said one or more display screens during operation of said electronic data processing unit by said user a plurality of advertisements;
wherein said plurality of advertisements displayed are based on said plurality of information about said user gathered by said electronic data processing unit as said user operates said electronic data processing unit.

3. The computer-based method of optimizing a user interface for an electronic data processing unit of claim 2, the steps further comprising:
purchasing a plurality of goods on said electronic data processing unit by said user;
wherein said plurality of information about said user gathered as said user operates said electronic data processing is further comprised of said plurality of goods purchased by said user; and
displaying by said electronic data processing unit a plurality of advertisements based on said plurality of goods purchased by said user.

4. The computer-based method of optimizing a user interface for an electronic data processing unit of claim 3, the steps further comprising:
displaying by said electronic data processing unit on said one or more display screens a home screen;
wherein said home screen is comprised of a plurality of channel bars; and
wherein said plurality of channel bars are comprised of said plurality of applications, said plurality of utilities, and said plurality of content files.

5. The computer-based method of optimizing a user interface for an electronic data processing unit of claim 3, the steps further comprising:
organizing said plurality of channel bars on said one or more display screens based on said plurality of frequencies at which said plurality of applications, said plurality of utilities, and said plurality of content files are accessed.

6. The computer-based method of optimizing a user interface for an electronic data processing unit of claim 5, wherein said home screen is further comprised of a dock;
wherein said dock is displayed on said one or more display screens by said electronic data processing unit.

7. The computer-based method of optimizing a user interface for an electronic data processing unit of claim 6, wherein said dock is comprised of at least one short cut bar and at least one access bar;
wherein said at least one short cut bar is comprised of at least one selected application of said plurality of applications;
wherein said at least one selected application is directly accessible by said user from said at least one short cut bar;
wherein said at least one access bar is comprised of at least one selected utility of said plurality of utilities; and
wherein said at least one selected utility is directly accessible by said user from said at least access bar.

8. The computer-based method of optimizing a user interface for an electronic data processing unit of claim 7, wherein said plurality of channel bars is comprised of a purchasing bar;
wherein said purchasing bar is comprised of one or more purchasing utilities.

9. The computer-based method of optimizing a user interface for an electronic data processing unit of claim 8, wherein said one or more purchasing utilities is comprised of an applications purchasing utility and a goods purchasing utility.

10. The computer-based method of optimizing a user interface for an electronic data processing unit of claim 9, wherein said plurality of utilities is comprised of a digital photo frame utility.

11. The computer-based method of optimizing a user interface for an electronic data processing unit of claim 10, wherein said digital photo frame utility is comprised of one or more digital images, a weather display, a date display, a time display, a social network display, and at least one of said one or more purchasing utilities.

12. The computer-based method of optimizing a user interface for an electronic data processing unit of claim 11, wherein said plurality of utilities is further comprised of a settings utility;
wherein said settings utility allows said user to customize said electronic data processing unit; and
wherein said computer-based method further comprises a step of:
customizing by said user said electronic data processing unit through said settings utility.

13. The computer-based method of optimizing a user interface for an electronic data processing unit of claim 12, wherein said settings utility is comprised of one or more data gathering applications; and
accessing by said user said one or more data gathering applications;
answering by said user a plurality of questions posed by said one or more data gathering applications;
gathering by said electronic data processing unit one or more answers provided by said user; and
combining by said electronic data processing unit said one or more answers provided by said user with said plurality of information about said user gathered by said electronic data processing unit as said user operates said electronic data processing unit.

14. The computer-based method of optimizing a user interface for an electronic data processing unit of claim 13, wherein said electronic data processing unit is mobile.

15. A mobile electronic data processing unit optimized to enhance the user interface based on usage, comprising:
a mobile electronic data processing unit;
wherein said mobile electronic data processing unit is comprised of one or more display screens, a plurality of applications; a plurality of utilities; a plurality of content files;
wherein said plurality of applications, said plurality of utilities, and said plurality of content files are displayed on said one or more display screens;
wherein as said user operates said mobile electronic data processing unit, said mobile electronic data processing unit gathers a plurality of information about said user;
gathering said plurality of information about said user by said mobile electronic data processing unit;
determining by said mobile electronic data processing unit a plurality of frequencies at which of said plurality of applications, said plurality of utilities, and said plurality of content files are accessed; and
organizing said plurality of applications, said plurality of utilities, and said plurality of content files by said mobile electronic data processing unit on said one or more display screens based on said plurality of frequencies at which said plurality of applications, said plurality of utilities, and said plurality of content files are accessed.

16. The mobile electronic data processing unit optimized to enhance the user interface based on usage of claim 15, wherein said user purchases a plurality of goods on said mobile electronic data processing unit;
wherein said plurality of information about said user gathered as said user operates said mobile electronic data processing is further comprised of said plurality of goods purchased by said user;
wherein said mobile electronic data processing unit displays a plurality of advertisements on said one or more display screens during operation of said mobile electronic data processing unit by said user;
wherein said plurality of advertisements displayed are based on said plurality of information about said user gathered by said mobile electronic data processing unit as said user operates said mobile electronic data processing unit.

17. The mobile electronic data processing unit optimized to enhance the user interface based on usage of claim 16, wherein said mobile electronic data processing unit is further comprised of a home screen;
wherein said home screen is displayed on said one or more display screens;
wherein said home screen is comprised of a plurality of channel bars;
wherein said plurality of channel bars are comprised of said plurality of applications, said plurality of utilities, and said plurality of content files;
wherein said mobile electronic data processing unit organizes said plurality of channel bars on said one or more display screens based on said plurality of frequencies at which said plurality of applications, said plurality of utilities, and said plurality of content files are accessed by said user.

18. The mobile electronic data processing unit optimized to enhance the user interface based on usage of claim 17, wherein said home screen is further comprised of a dock;
wherein said dock is comprised of at least one short cut bar and at least one access bar;
wherein said at least one short cut bar is comprised of at least one selected application of said plurality of applications;
wherein said at least one selected application is directly accessible by said user from said at least one short cut bar;
wherein said at least one access bar is comprised of at least one selected utility of said plurality of utilities;
wherein said at least one selected utility is directly accessible by said user from said at least one access bar;
wherein said plurality of channel bars is comprised of a purchasing bar;
wherein said purchasing bar is comprised of one or more purchasing utilities; and
wherein said one or more purchasing utilities is comprised of an applications purchasing utility and a goods purchasing utility.

19. The mobile electronic data processing unit optimized to enhance the user interface based on usage of claim 18, wherein said plurality of utilities is comprised of a digital photo frame utility and a settings utility;
wherein said digital photo frame utility is comprised of one or more digital images, a weather display, a date display, a time display, a social network display, and at least one of said one or more purchasing utilities;
wherein said settings utility allows said user to customize said mobile electronic data processing unit;
wherein said user uses said settings utility to customize said mobile electronic data processing unit;
wherein said settings utility is comprised of one or more data gathering applications;
wherein said user accesses said one or more data gathering applications and provides a one or more answers to a plurality of questions posed by said one or more data gathering applications; and
wherein said mobile electronic data processing unit combines said one or more answers provided by said user with said plurality of information about said user gathered by said mobile electronic data processing unit as said user operates said mobile electronic data processing unit.

20. A computer-based method of optimizing a user interface for an electronic data processing unit, the steps comprising:
providing a mobile electronic data processing unit;
wherein said mobile electronic data processing unit is comprised of one or more display screens, a plurality of applications; a plurality of utilities, a plurality of content files, and a home screen;
wherein said home screen is comprised of a dock and a plurality of channel bars;
wherein said dock is comprised of at least one short cut bar and at least one access bar;
wherein said at least one short cut bar is comprised of at least one selected application of said plurality of applications;
wherein said at least one access bar is comprised of a digital photo frame utility and a settings utility;
wherein one of said plurality of channel bars is a purchasing bar;
wherein said purchasing bar is comprised of one or more purchasing utilities;
wherein said one or more purchasing utilities is comprised of an applications purchasing utility and a goods purchasing utility;
wherein said digital photo frame utility is comprised of one or more digital images, a weather display, a date display, a time display, a social network display, at least one of said one or more purchasing utilities;
wherein said settings utility allows a user to customize said mobile electronic data processing unit;
wherein said settings utility is comprised of one or more data gathering applications;
operating said mobile electronic data processing unit by said user to access said plurality of applications, said plurality of utilities, and said plurality of content files;
purchasing a plurality of goods by said user with said goods purchasing utility;
purchasing a plurality of new applications by said user with said applications purchasing utility;
gathering by said mobile electronic data processing unit a plurality of information about said user as said user operates said mobile electronic data processing unit;
accessing by said user said one or more data gathering applications;
answering by said user a plurality of questions posed by said one or more data gathering applications;
gathering by said mobile electronic data processing unit one or more answers provided by said user;
wherein said plurality of information includes said plurality of goods purchased by said user, said plurality of new applications purchased by said user, and said one or more answers provided by said user;
determining by said mobile electronic data processing unit a plurality of frequencies at which said plurality of applications, said plurality of utilities, and said plurality of content files are accessed;
organizing said plurality of applications, said plurality of utilities, and said plurality of content files by said mobile electronic data processing unit on said one or more display screens based on said plurality of frequencies at which said plurality of applications, said plurality of utilities, and said plurality of content files are accessed;
displaying by said mobile electronic data processing unit on said one or more display screens during operation of said mobile electronic data processing unit by said user a plurality of advertisements;
wherein said plurality of advertisements displayed are based on said plurality of information about said user gathered by said electronic data processing unit as said user operates said electronic data processing unit; and
organizing said plurality of channel bars on said one or more display screens based on said plurality of frequencies at which said plurality of applications, said plurality of utilities, and said plurality of content files are accessed.
